(19) United States
(12) Patent Application Publication
(10) Pub. No.: US 2025/0004289 A1
(43) Pub. Date: Jan. 2, 2025

(54) MULTIPLE-SOURCE LASER DISPLAY SYSTEM

(71) Applicant: Google LLC, Mountain View, CA (US)

(72) Inventors: Aurelien Jean Francois David, San Francisco, CA (US); Benjamin Wales, Waterloo (CA); Bergen Albert Fletcher, St. Jacobs (CA); Daniel Adema, Kitchener (CA); Daniel J. Effinger, Squamish (CA); Vance R. Morrison, Kitchener (CA); Patrick F. Brinkley, San Mateo, CA (US); Ian Andrews, Kitchener (CA); Stuart James Myron Nicholson, Waterloo (CA); Shreyas Potnis, Kitchener (CA)

(21) Appl. No.: 18/697,661

(22) PCT Filed: Sep. 29, 2022
(86) PCT No.: PCT/US2022/045162

§ 371 Date: Apr. 1, 2024

Related U.S. Application Data
(60) Provisional application No. 63/251,320, filed on Oct. 1, 2021.

(51) Int. Cl. G02B 27/10; G02B 26/08; G02B 27/01; G02B 27/12

(52) U.S. Cl. CPC G02B 27/1006; G02B 26/0816; G02B 27/0172; G02B 27/123

(57) ABSTRACT

A display system includes one or more low-power laser diodes, each producing an emission. The emissions are directed to an optical element that affects the direction or divergence of the emissions. The optical element redirects the emissions toward a steering element such as a MEMS-actuated mirror, or a combination of such mirrors. The steering element directs the emissions toward the incoupler of a waveguide acting as an optical combiner. The emissions propagate through the waveguide and are extracted by an outcoupler in the direction of an observer. By scanning the direction of the beam-steering element along one or several directions, an image may be formed.

### BACKGROUND

Some display systems employ a projector, which is an optical device that projects or shines a pattern of light onto another object (e.g., onto a surface of another object, such as onto a projection screen or retina) to display an image or video on or via that other object. In projectors employing lasers as light sources (i.e., a “laser projector”), each beam of laser light generated by the laser projector is temporally modulated to provide a pattern of laser light and controllable mirrors, such as micro-electromechanical system (MEMS) mirrors rotatable about a single axis (1-D) or about two axes (2-D), are typically used to focus the modulated pattern of laser light at a point on another object or to spatially distribute the modulated pattern of laser light over a two-dimensional area of another object. Conventional laser-based display systems employ three laser emitters, one for each primary color (red, green, and blue). However, the use of one emitter per primary color may have drawbacks including the need for a high power for each emitter.

In the field of optics, a combiner is an optical apparatus that combines two light sources. For example, an optical combiner may combine light transmitted from a laser projector or other light source directed to the optical combiner with environmental light originating from the real world outside of the optical combiner. Optical combiners are used in wearable display devices (which include head-mounted displays (HMDs), heads-up displays (HUDs), and near-eye displays), which allow a user to view computer-generated content (e.g., textual, graphical, or video content) superimposed over a user's environment and viewed through the HMD. The HMD enables a user to view the computer-generated content without having to significantly shift their line of sight. The wearable electronic eyewear device can therefore serve as a hardware platform for implementing augmented reality (AR) or mixed reality (MR), which are used interchangeably herein. Different modes of augmented reality include optical see-through augmented reality, video see-through augmented reality, or opaque (VR) modes.

### SUMMARY OF EMBODIMENTS

In accordance with one aspect, a device includes a first array comprising a plurality of lasers to emit a first color light. The device includes a second array comprising a plurality of lasers to emit a second color light, wherein each laser of the first array and the second array is modulated in time and has a maximum output power less than 10 mW. The device includes an optical element optically coupled to the first array and the second array, a steering element optically coupled to the optical element, and an optical combiner optically coupled to the steering element. The optical element is configured to direct emissions from the first array and the second array to form a light that impinges on the steering element. The steering element is modulated in time to direct the light in an angular range in which it is optically coupled to the optical combiner. The optical combiner is configured to redirect the light to an eyebox, where the light forms a substantially white image having a brightness of at least 1000 nits.

In at least some embodiments, emissions from any two contiguous lasers in the first array impinge on the steering element with directions separated by an angle less than 5 degrees.

In at least some embodiments, each laser and the steering element are jointly modulated in time to form the substantially white image.

In at least some embodiments, the light impinges on the steering element on an area less than 2 mm².

In at least some embodiments, the substantially white image has a chromaticity which is substantially similar to D65 chromaticity, characterized by a chromatic distance Du‘v’ less than 0.05, and subtends a solid angle of at least 1 deg×1 deg.

In accordance with another aspect, a method includes modulating in time and emitting a first color light from a first array comprising a plurality of lasers, each laser having a maximum output power less than 10 mW. The method further includes modulating in time and emitting a second color light from a second array comprising a plurality of lasers, each laser having a maximum output power less than 10 mW. An optical element is optically coupled to the first array and the second array to form a light that impinges on a steering element. The steering element is modulated in time to direct the light in an angular range in which the steering element is optically coupled to an optical combiner. The light is redirected by the optical combiner to an eyebox to form a substantially white image having a brightness of at least 1000 nits.

In at least some embodiments, the method further includes emitting light from any two contiguous lasers in the first array to impinge on the steering element with directions separated by an angle less than 5 degrees.

In at least some embodiments, the method further includes modulating each laser and the steering element in time to form the substantially white image.

In at least some embodiments, the light impinges on the steering element on an area less than 2 mm².

In at least some embodiments, the substantially white image has a chromaticity which is substantially similar to D65 chromaticity, characterized by a chromatic distance Du‘v’ less than 0.05, and subtends a solid angle of at least 1 deg×1 deg.

In accordance with another aspect, a laser-scanning display system includes a blue array comprising a plurality of blue vertical-cavity surface-emitting lasers (VCSELs) optically coupled to a first micro-lens array comprising a plurality of lenses, each lens optically coupled to a laser in the blue array. The laser-scanning display system includes a green array comprising a plurality of green VCSELs optically coupled to a second micro-lens array comprising a plurality of lenses, each lens optically coupled to a laser in the green array. The laser-scanning display system further includes a red array comprising a plurality of red VCSELs optically coupled to a third micro-lens array comprising a plurality of lenses, each lens optically coupled to a laser in the red array. A steering element is optically coupled to the first, second, and third micro-lens arrays. An optical combiner is optically coupled to the steering element, and the lenses of the micro-lens arrays are configured such that at least 20% of an optical power characterizing emission of light emitted from each VCSEL reaches the steering element.

In at least some embodiments, at least 30% of the optical power characterizing emission of light emitted from each VCSEL reaches the steering element.

In at least some embodiments, the first micro-lens array is configured such that emissions from all the blue VCSELs are combined into a beam.

In at least some embodiments, each VCSEL of the blue array is characterized by a beam angle, and an optical interaction with lens modifies the beam angle.

In at least some embodiments, the first micro-lens array is configured such that emissions from the plurality of blue VCSELs substantially overlap at the steering element.

In at least some embodiments, each VCSEL in the blue array has an output power less than 10 mW.

In at least some embodiments, the system can be operated to form a substantially white image having a brightness of at least 1000 nits.

In accordance with another aspect, an augmented reality display system includes a first plurality of blue vertical-cavity surface-emitting lasers (VCSELs), wherein each VCSEL has an output power less than 10 mW, a second plurality of green VCSELs, and a third plurality of red VCSELs. An optical system is optically coupled to the third, second and third pluralities of VCSELs and is configured to form an image from light emitted from the third, second and third pluralities of VCSELs. An eye-tracking element is included, and electrical powers controlling each VCSEL in the first, second and third pluralities are modulated based on data from the eye-tracking element to facilitate formation of the image.

In at least some embodiments, one or more VCSELs are turned on or off based on data from the eye-tracking element.

In at least some embodiments, the augmented reality display system has an eyebox and modulation of the electrical powers controlling each VCSEL causes the eyebox to vary.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a schematic arrangement of multiple-laser emitters in accordance with some embodiments.

FIG. 2 is a block diagram of a display system including multiple laser diodes in accordance with some embodiments.

FIG. 3 is a block diagram of a display system including multiple laser diodes optically coupled to a collimator in accordance with some embodiments.

FIG. 4 is a block diagram of a display system including multiple laser diodes optically coupled to a microlens array in accordance with some embodiments.

FIG. 5 is a block diagram of a display system including multiple laser diodes optically coupled to a microlens array and an optical element in accordance with some embodiments.

FIG. 6 is an illustration of light beams overlapping a light-steering element in accordance with some embodiments.

FIG. 7 is a graph illustrating how individual beams can be combined to form a beam with a desired profile in accordance with some embodiments.

FIG. 8 is a block diagram of a display system including multiple laser diodes optically coupled to a microlens array and an optical element in accordance with some embodiments.

FIG. 9 is a block diagram of a display system including multiple arrays of laser diodes in accordance with some embodiments.

FIG. 10 is an illustration of an image including multiple sub-images in accordance with some embodiments.

FIG. 11 is an illustration of an image formed with a two-dimensional array of emitters in accordance with some embodiments.

FIG. 12 is an illustration of an image including multiple sub-images in accordance with some embodiments.

FIG. 13 is an illustration of an image including multiple sub-images of varying resolutions in accordance with some embodiments.

FIG. 14 is an illustration of an image converted in time sequences to drive a multiple-laser display system in accordance with some embodiments.

FIG. 15 is an illustration of a one-dimensional array of ridge lasers in accordance with some embodiments.

FIG. 16 is an illustration of two-dimensional arrays of vertical-cavity surface-emitting lasers in accordance with some embodiments.

FIG. 17 illustrates a cross-section of an example where three arrays are stacked together vertically in accordance with some embodiments.

FIG. 18 illustrates a fabrication flow for an array of lasers attached to drivers in accordance with some embodiments.

FIG. 19 a process of forming a microlens array in accordance with some embodiments.

FIG. 20 is a block diagram of a geometric guide combiner in accordance with some embodiments.

FIG. 21 is an illustration of a display region in relation to a pupil position in accordance with some embodiments.

### DETAILED DESCRIPTION

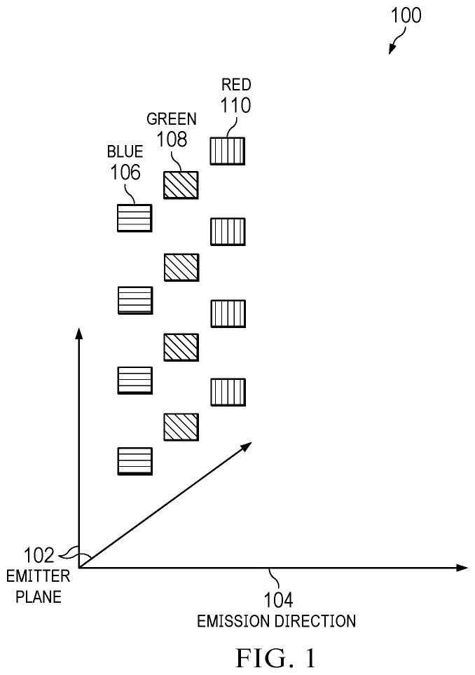

High-power laser diodes consume large amounts of power and have imperfect characteristics. Low-power laser diodes such as vertical-cavity surface-emitting lasers (VCSELs) use less power but also produce less light than high-power laser diodes. FIGS. 1-21 illustrate techniques for incorporating multiple low-power laser emitters into a display system. In some embodiments, a display system includes at least two blue lasers, two green lasers, and two red lasers. Emission from these lasers is directed to an optical combiner and then to the eye of a user. In other examples, the display system includes one low-power laser for each color that is optically coupled with efficient optics to produce a brighter display.

The display system includes a first array of lasers to emit a first color light and a second array of lasers to emit a second color light in some examples. Each laser is modulated in time and has a maximum output power that is less than 10 mW. An optical element is optically coupled to the first array and the second array and a steering element is optically coupled to the optical element, as well as an optical combiner that is optically coupled to the steering element. Thus, light emitted from the first array and the second array impinges on the steering element, which is modulated in time to direct the light in an angular range in which the light is optically coupled to the optical combiner. In some examples, the light impinges on the steering element on an area less than 2 mm². The optical combiner is configured to redirect the light to an eyebox, where the light forms a substantially white image having a brightness of at least 1000 nits. Herein, the “eyebox” of a display refers to the range of different user eye positions that will be able to see the display.

In some cases, emissions from any two contiguous lasers in the first array impinge on the steering element with directions separated by an angle less than 5 degrees and the time modulation of each laser and the time modulation of the steering element are configured together to form the substantially white image. The substantially white image has a chromaticity that is substantially similar to D65 chromaticity, characterized by a chromatic distance Du‘v’ less than 0.05, and subtends a solid angle of at least 1 deg×1 deg.

In some examples, a laser-scanning display system includes an array of blue vertical-cavity surface-emitting lasers (VCSELs) optically coupled to a first micro-lens array, an array of green VCSELs optically coupled to a second micro-lens array, and an array of red VCSELs optically coupled to a third micro-lens array. Each micro-lens array has a microlens that is optically coupled to a VCSEL in the corresponding VCSEL array. The system includes a steering element optically coupled to the first, second, and third micro-lens arrays and an optical combiner optically coupled to the steering element. The lenses of the micro-lens arrays are configured such that a substantial fraction of light emitted from each VCSEL substantially reaches the steering element. In some examples, the substantial fraction is at least 30% of an optical power characterizing each emission.

In some examples, the first micro-lens array is configured such that the emission from each of the corresponding VCSELs is combined into a beam. Each VCSEL of the array is characterized by a beam angle, and an optical interaction with lens modifies the beam angle. In some examples, the first micro-lens array is configured such that emissions from the plurality of VCSELs substantially overlap at the steering element. Each VCSEL in the blue array has an output power less than 10 mW in some examples.

In some examples, an augmented reality display system includes a first plurality of blue VCSELs, a second plurality of green VCSELs, and a third plurality of red VCSELs, each VCSEL having an output power less than 10 mW. An optical system is optically coupled to the third, second and third pluralities of VCSELs and is configured to form an observable image. An eye-tracking element generates data based on which electrical powers controlling each VCSEL in the first, second and third pluralities are modulated to facilitate the formation of the image. For example, in some embodiments some VCSELs are turned on or off based on data from the eye-tracking element. In some embodiments, the display system has an eyebox and the modulated powers cause the eyebox to vary.

FIG. 1 shows a schematic arrangement 100 of multiple-laser emitters. It includes an array of blue lasers 106, an array of green lasers 108, and an array of red lasers 110. The lasers are positioned in an emitter plane 102 and emit radiation in an emission direction 104. In some embodiments, the emission direction 104 is perpendicular to the emitter plane 102.

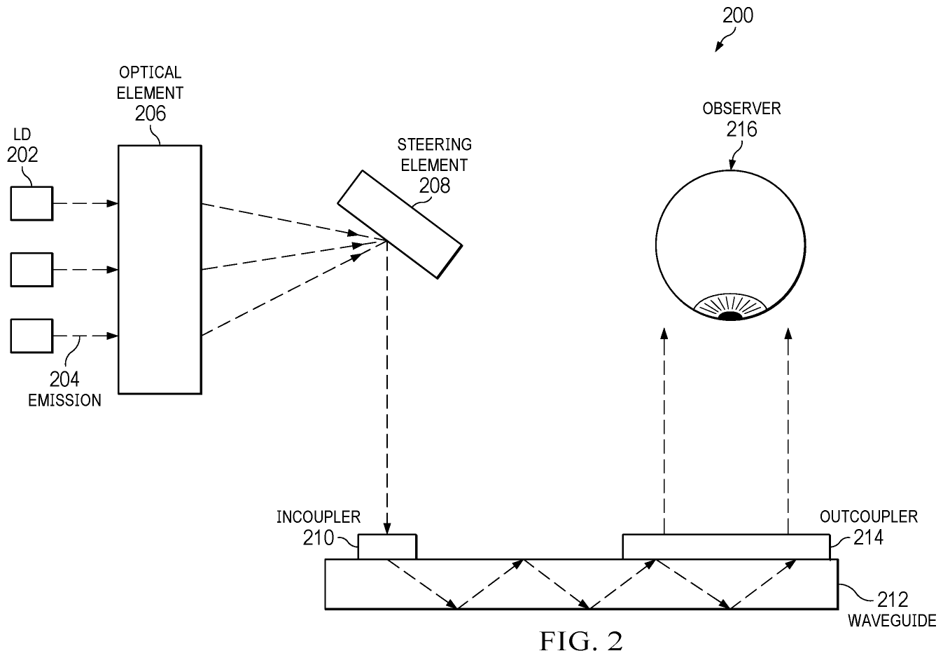

FIG. 2 shows a simplified diagram of a display system 200 that projects images directly onto the eye of a user via laser light. The display system 200 includes multiple laser diodes 202, each producing an emission 204, an optical element 206, a steering element 208, and a waveguide 212. The waveguide 212 includes an incoupler 210 and an outcoupler 214, with the outcoupler 214 being optically aligned with an eye 216 of an observer in the present example. In some embodiments, the display system 200 is implemented in a wearable heads-up display.

The laser diodes 202 are configured to generate and output laser light emissions 204 (e.g., visible laser light such as red, blue, and green laser light). In some embodiments, the laser diodes 202 are part of an optical engine that is coupled to a driver or other controller (not shown), which controls the timing of emission of laser light from the laser diodes 202 in accordance with instructions received by the controller or driver from a computer processor coupled thereto to modulate the emissions 204 to be perceived as images when output to the retina of the eye 216 of an observer.

For example, during operation of the display system 200, multiple laser light beams having respectively different wavelengths are output by the laser diodes 202, then combined via the waveguide 212, before being directed to the eye 216 of the observer. The laser diodes 202 modulate the respective intensities of the laser light beams so that the combined laser light reflects a series of pixels of an image, with the particular intensity of each laser light beam at any given point in time contributing to the amount of corresponding color content and brightness in the pixel being represented by the combined laser light at that time.

The emissions 204 are directed to an optical element 206 such as a lens, a collimator, a lens array, or other optical constructs known in the art. The optical element 206 affects the emissions 204, e.g., by changing the divergence or direction of the emitted light beams. The output after the emissions 204 interact with the optical element 206 may be a set of collimated beams, or a set of beams with different directions characterized by an angular separation. Two or more laser light beams are “angularly separated” when they propagate along respectively different non-parallel and non-perpendicular optical paths that are tilted (e.g., angularly offset) with respect to one another, with the angular separation of the optical paths, in some instances, causing the two or more laser light beams to converge to overlap one another along one or more dimensions. The optical element 206 redirects the emissions 204 toward a steering element 208 such as a MEMS-actuated mirror, or a combination of such mirrors.

The steering element 208 directs the emissions 204 toward an incoupler 210 of a waveguide 212 that acts as an optical combiner. In some embodiments, the steering element 208 is one or more MEMS mirrors that are driven by respective actuation voltages to oscillate during active operation of the display system 200, causing the steering element 208 to scan the emissions 204. Oscillation of the steering element causes the emissions to be scanned toward the incoupler 210 of the waveguide 212.

The incoupler 210 is configured to receive the emissions 204 and direct the laser light into the waveguide 212. The term “waveguide,” as used herein, will be understood to mean a combiner using one or more of total internal reflection (TIR), specialized filters, or reflective surfaces, to transfer light from an incoupler (such as the incoupler 210) to an outcoupler (such as the outcoupler 214). In some display applications, the light is a collimated image, and the waveguide 212 transfers and replicates the collimated image to the eye 216. In general, the terms “incoupler” and “outcoupler” will be understood to refer to any type of optical grating structure, including, but not limited to, diffraction gratings, holograms, holographic optical elements (e.g., optical elements using one or more holograms), volume diffraction gratings, volume holograms, surface relief diffraction gratings, or surface relief holograms.

In some embodiments, a given incoupler or outcoupler is configured as a transmissive grating (e.g., a transmissive diffraction grating or a transmissive holographic grating) that causes the incoupler or outcoupler to transmit light and to apply designed optical function(s) to the light during the transmission. In some embodiments, a given incoupler or outcoupler is a reflective grating (e.g., a reflective diffraction grating or a reflective holographic grating) that causes the incoupler or outcoupler to reflect light and to apply designed optical function(s) to the light during the reflection. In the present example, the laser light 218 received at the incoupler 210 is relayed to the outcoupler 214 via the waveguide 205 using TIR. The laser light 218 is then output to the eye 216 of a user via the outcoupler 214. As described above, in some embodiments the waveguide 205 is implemented as part of an eyeglass lens.

Although not shown in the example of FIG. 2, in some embodiments additional optical components are included in any of the optical paths between the laser diodes 202 and the steering element 208, between the steering element 208 and the incoupler 210, between the incoupler 210 and the outcoupler 214, or between the outcoupler 214 and the eye 216 (e.g., in order to shape the laser light for viewing by the eye 216 of the user). In some embodiments, a prism is used to steer light from the steering element 208 into the incoupler 210 so that light is coupled into incoupler 210 at the appropriate angle to encourage propagation of the light in the waveguide 212 by TIR. Also, in some embodiments, an exit pupil expander, such as a fold grating, is arranged in an intermediate stage between the incoupler 210 and the outcoupler 214 to receive light that is coupled into the waveguide 212 by the incoupler 210, expand the light, and redirect the light towards the outcoupler 214, where the outcoupler 214 then couples the laser light out of waveguide 212 (e.g., toward the eye 216 of the user).

The emissions 204 propagate through the waveguide 212 and are extracted by an outcoupler 214 in the direction of an observer. By scanning the direction of the beam-steering element along one or several directions, an image may be formed for viewing by the observer.

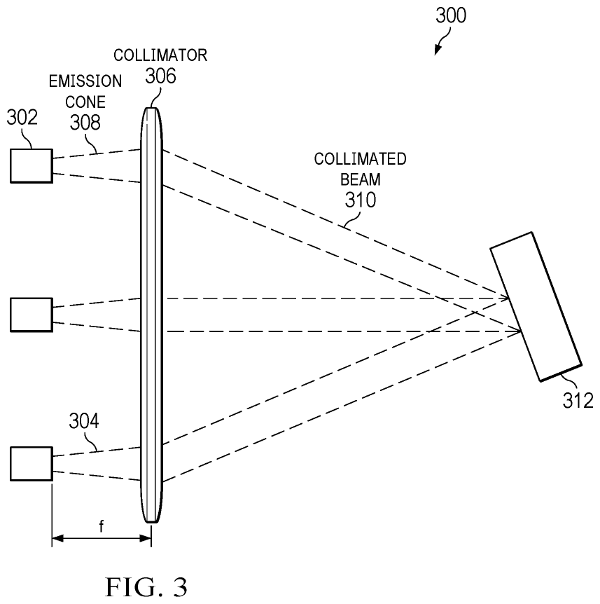

Emissions from multiple lasers (e.g., from laser arrays) can be combined in various ways. FIG. 3 shows an example display system 300 where several lasers 302 are optically coupled to a collimator 306. For clarity, beam paths are shown in dashed lines. The emission 304 from each laser 302 is characterized by an emission cone 308 (for specificity, this can be the cone at which the beam intensity reaches a value 1/e, in the well-known case of a Guassian beam profile). The lasers 302 are placed in focus with the collimator 306. Each beam is then collimated by the collimator 306. The resulting output is a combination of collimated beams 310, each with slightly different propagation angles. The collimated beams 310 are characterized by an angular separation. For clarity, the angular separation characterizes the angle between two adjacent beams (coming from two adjacent lasers in the array). A steering element 312 is placed at the locus where the collimated beams 310 overlap substantially. In this example, the surface of the reflective element 312 is planar, so the reflected beams (not shown) are also collimated, with the same angular separation.

The angular separation can be controlled by selecting the effective focal length f of the collimator 306, and the spacing between the lasers 302. In some examples, the angular separation is about 0.5 deg (or 1 deg, 1.5 deg, 2 deg, 3 deg, 5 deg, 10 deg). In some examples, this separation is defined with a range of +/−0.5 deg (or 0.2 deg, 0.1 deg, 0.05 deg, 0.01 deg). The impact of angular separation on the displayed signal will be discussed hereafter.

In this example, multiple laser beams can be made to impinge on a steering element 312 within the same area. This may be desirable if the steering element 312 is small. For instance, a MEMS mirror may have a reflective area of less than 1 mm² (or 1.5 mm², 2 mm², 3 mm², 5 mm², 10 mm²). The multiple beams may substantially overlap with a reflective area of the steering element 312. For instance, at least 50% (or 80%, or 90%) of the power carried by each beam substantially overlaps just before impinging on the reflective area of the steering element 312. Combining the multiple beams into a substantially overlapping beam enables high power efficiency, and hence a high display brightness.

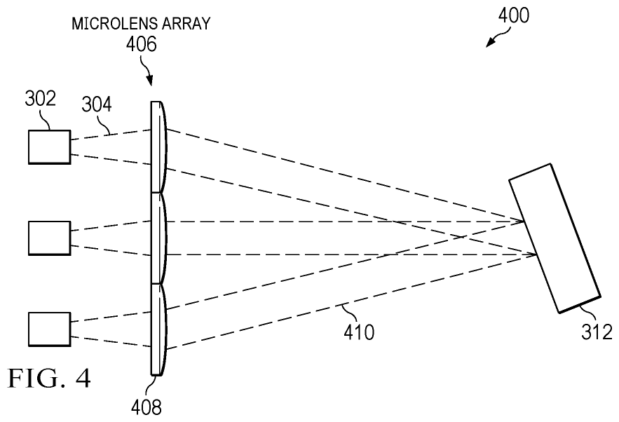

FIG. 4 shows an example display system 400 where several lasers 302 are optically coupled to a microlens array 406. Herein, a microlens array 406 refers to an optical element including several optical sub-elements (e.g., microlenses or more complex structures), each optical sub-element affecting the emission 304 of one of the lasers 302. In this example, the emission 304 of each laser 302 is focused by a corresponding microlens 408 into a collimated beam 410. The optical axis of each microlens 408 is slightly offset from the optical axis of the corresponding laser 302, such that collimated beams 410 intersect. Similar to the display system 300 of FIG. 3, a steering element 312 is placed at the locus where the collimated beams 410 overlap substantially. The angular separation between sub-beams can be controlled by selecting the design of the microlens array 406, including the focal length of the microlenses 408 and their dimensions and spacing.

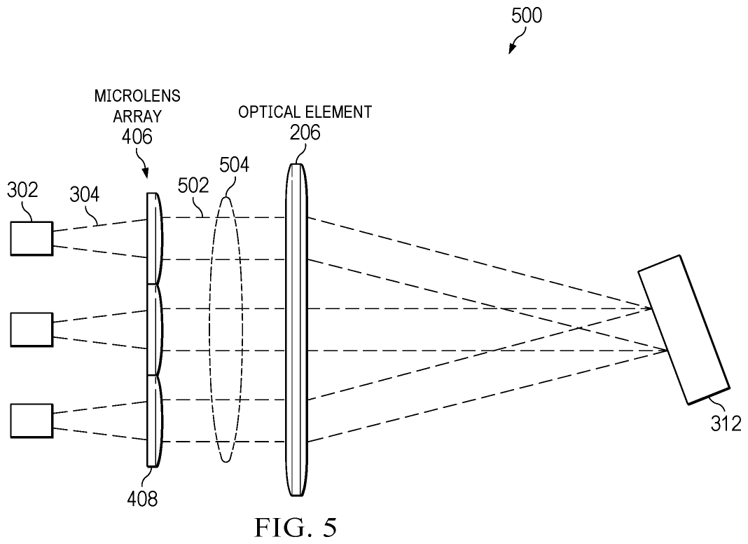

FIG. 5 shows an example display system 500 where several lasers 302 are optically coupled to a microlens array 406 and further coupled to an optical element 206. The microlens array 406 collimates an emission 304 from each laser 302 into a collimated beam 502, and each laser 302 is aligned with the corresponding lens 408, such that the collated beams 502 are parallel with each other at the output of the microlens array 406, forming a collimated combined beam 504. The optical element 206 then focuses this combined beam 504 on a steering element 312.

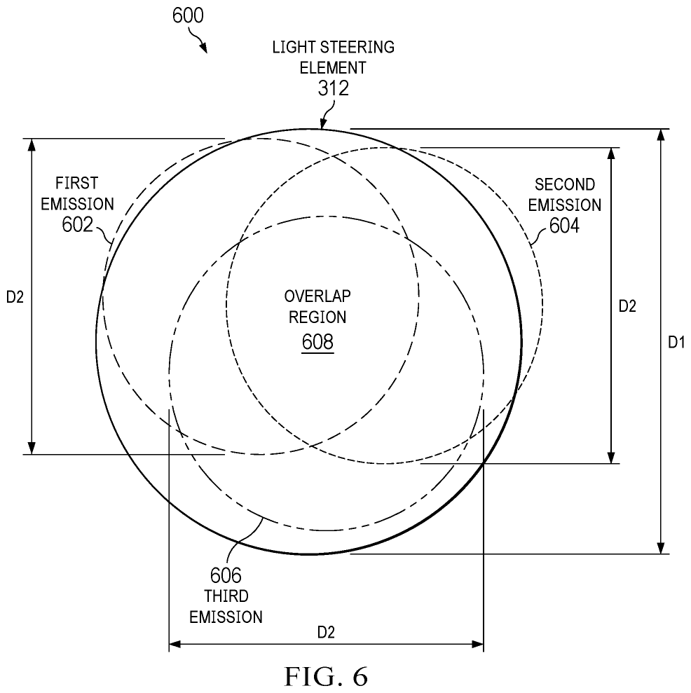

FIG. 6 shows an illustration 600 of beams overlapping a light-steering element 312. The light-steering element 312 is substantially circular, with a diameter D1. Each of a first emission 602, a second emission 604, and a third emission 606 from a set of laser diodes (not shown) reaches the beam-steering element 312 with a beam that is approximately circular, with a beam diameter D2. In some cases, D2 may be a characteristic diameter for the laser beam (for instance, a diameter in which more than 80% of the beam power is contained). Each of the beams overlaps significantly with the light steering element 312. In some examples, at least 50% (or 70%, 80%, 90%) of the power of each laser beam overlaps with the light steering element 312. In some examples, D2<D1 (or D2<D1*0.8 or D2<D1*0.5). The laser beams further overlap each other in an overlap region 608. In some embodiments, the overlap region 608 is fully enclosed in the light steering element 312. In some embodiments, at least 30% (or 50%, 70%, 80%, 90%) of the power of each beam is in the overlap region 608. For clarity, the beam powers mentioned here are the powers when each beam reaches the light steering element 312.

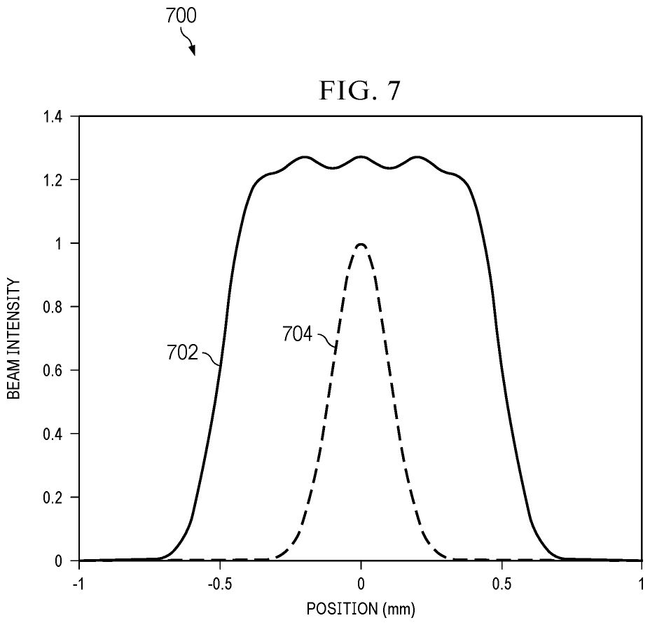

FIG. 7 is an illustration 700 showing how, in the configuration of FIG. 5, individual beams can be combined to form a beam with a desired profile. In this example, each single emitter is a single-mode laser with a Gaussian beam profile 704. After collimation by its microlens, each beam 704 has a standard deviation of 100 um (corresponding to a 1/e radius of about 140 um). By combining a linear array of five beams 704, with a distance of 200 um between the beam centers, a composite beam 702 is obtained with an approximately flat-top profile and a total diameter at half-height of about 1 mm. Within a center diameter of 700 um, the composite beam 702 profile is approximately constant, with a relative variation less than +/−3%. Although only a cross-section is shown in this example, such uniformity can be achieved in a plane perpendicular to the emission direction, for instance by combining beams from a 2-dimensional array of emitters. In some examples, a composite beam 702 is composed of at least 3 (or 4, 6, 9, 16) laser beams and has a relative intensity variation less than +/−20% (or 10%, 5%) within a predetermined radius (such as 0.1 mm, 0.2 mm, 0.5 mm, 1 mm, 1.5 mm, 2 mm) from the beam center.

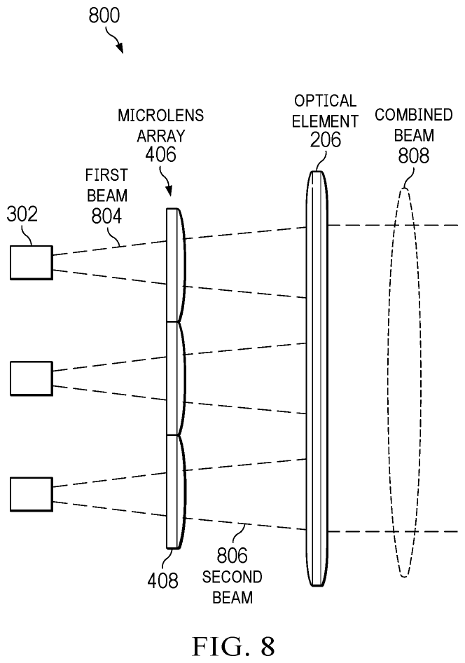

FIG. 8 shows an example display system 800 including several lasers 302 that are optically coupled to a microlens array 406 including microlenses 408 corresponding to each laser 302 and further coupled to an optical element 206. Each laser 302 emits a first beam 804 having a first beam angle. The corresponding microlens 408 steers the first beam 804 into a second beam 806 having a second beam angle. The second beams 806 impinge on an optical element 206. The optical axes of the lasers 302 and corresponding microlenses 408 are offset, such that the second beams 806 are steered in different directions from each other and approximately meet at the optical element 206. The optical element 206 then combines the second beams 806 beams into a combined beam 808. The combined beam 808 is shown as a collimated beam in this example (though this need not be the case).

In some embodiments, the profile of the combined beam 808 is configured as shown in FIG. 7. In this example, a combined beam 808 of a desired diameter can be obtained, independent of the spacing of the microlenses. For example, in some embodiments, the lasers 302 are spaced apart by about 50 um and the microlenses 408 are also spaced apart by a similar distance (modulo the offset), thus forming a microlens array 406 with a diameter of a few hundred um. The combined beam 808 may have a larger diameter, e.g., 1 mm or more.

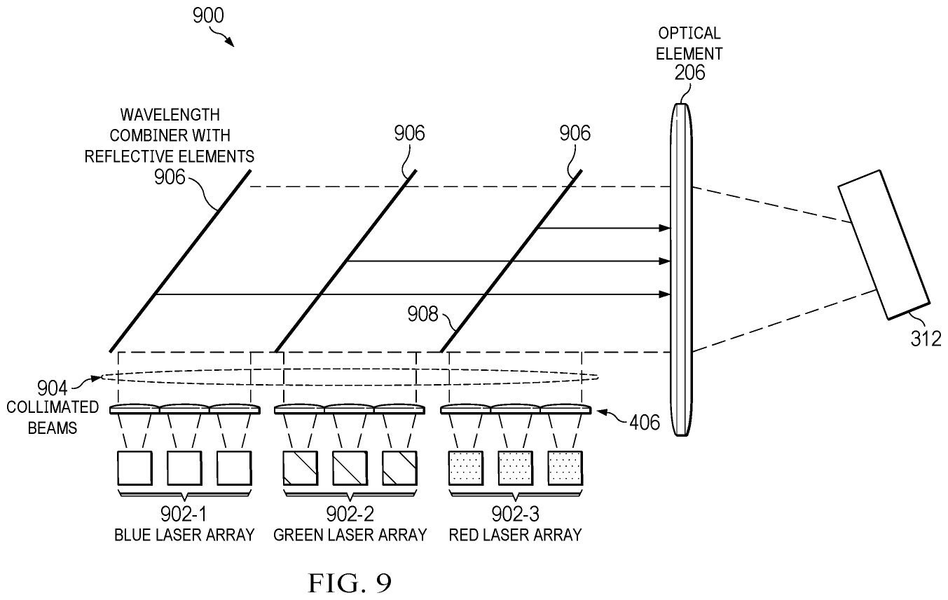

FIG. 9 shows how several arrays 902-1, 902-2, 902-3 of emitters can be combined in a system 900. The arrays 902-1, 902-2, 902-3 in this example correspond to different primaries (e.g., blue, green, red). Each array is first coupled to optical elements (shown here as a microlens array 406 for simplicity) that produce a set of collimated beams 904, each with a desired diameter. A wavelength combiner having three reflective elements 906 then combines the collimated beams 904. In some embodiments, the reflective elements 906 are wavelength-selective mirrors such as Bragg or dichroic mirrors. For example, the third mirror 908 illustrated in FIG. 9 reflects red light but is substantially transparent (e.g., more than 80% or 90% transmissive) for blue and green light. An optical element 206 focuses the combined beams on a steering element 312.

In other embodiments, the arrays corresponding to the three primaries are located proximate to each other and are coupled to the same optics. For example, red, green, and blue arrays may be coupled to the same microlens array 406, or to the same collimator, without the need for a wavelength combiner.

In some examples, the multiple emitters are not positioned on a plane but on a curved surface. For example, the lasers are placed on a flexible member in some embodiments. In such examples, the curvature may be selected to impart a desired initial direction to each beam. This may be combined with the use of optical elements, as discussed previously.

In some embodiments, the steering element is one or more one- or two-dimensional MEMS-actuated mirrors. The MEMS-actuated mirrors are encapsulated (for instance, with a flat or domed encapsulant) in some embodiments. The reflective surface may be a flat mirror (e.g., a metallic and/or dielectric mirror) and may include a diffractive element (e.g., a diffractive surface relief grating or volume holographic grating).

### Display Properties

In some examples, multiple beams are characterized by an angular separation after the steering element 312. The beams enter an optical combiner (for instance, a diffractive waveguide such as waveguide 212 or a geometric optic) which redirects radiation towards an observer. The angles of incidence of light on the combiner are translated into different regions of a displayed image. Therefore, beams having an angular separation result in multiple sub-images slightly offset from each other. These sub-images may be combined to form a displayed image.

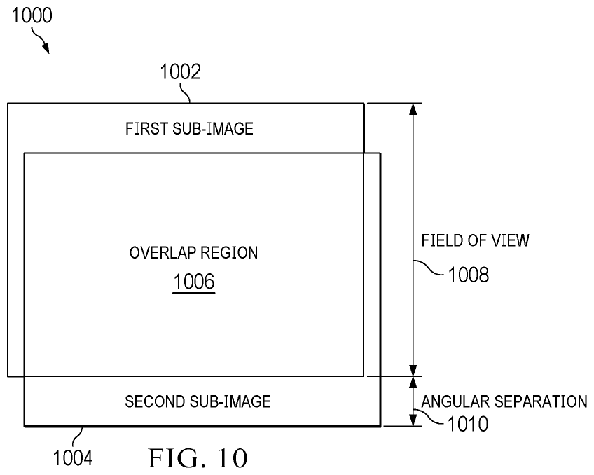

FIG. 10 shows an example of several sub-images 1002, 1004 forming an image 1000. For simplicity, only two sub-images 1002, 1004 are shown. Each sub-image is obtained by scanning the sub-beam of a laser along two directions with a steering element such as steering element 312. The two sub-images 1002, 1004 are offset in the vertical direction by an angular separation 1010. The vertical span of each sub-image 1002, 1004 corresponds to a field of view 1008. In an overlap region 1006, both sub-images 1002, 1004 overlap. The field of view 1008 may be at least 10 deg (or 15 deg, 20 deg, 30 deg, 40 deg, 50 deg). In the overlap region 1006, the brightness of the two sub-images 1002, 1004 add to form a brighter image. In the regions without overlap, only one laser contributes to the image.

In FIG. 10, the sub-images are offset along one direction, which can be achieved with a linear array of lasers. In some embodiments, the steering element 312 includes two mirrors: a fast-scanning mirror and a slow-scanning mirror. In such embodiments, it may be advantageous to have the linear array substantially aligned with the axis of the fast-scanning mirror. In other embodiments, the steering element 312 is a single mirror that can be scanned in two directions.

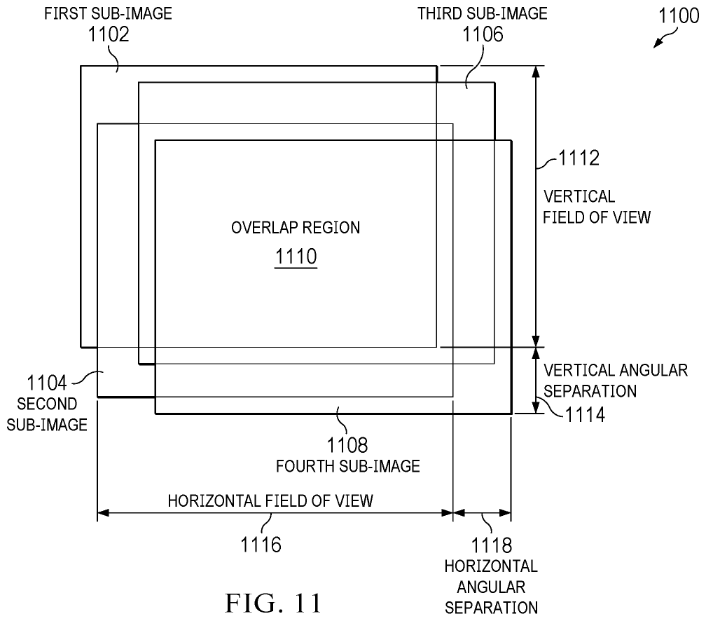

FIG. 11 shows an example image 1100 formed with a two-dimensional array of emitters—here a 2*2 array. A first sub-image 1102, a second sub-image 1104, a third sub-image 1106, and a fourth sub-image 1108 are offset in both vertical and a horizontal direction. In some embodiments, the angular separation is kept less than 0.25 deg (or 0.5 deg, 1 deg, 1.5 deg, 2 deg, 3 deg, 5 deg, 10 deg). The angular separation may be less than 1% (or 2%, 5%, 10%, 20%) of the field of view of each image. In such embodiments, the overlap region 1110 is maximized, facilitating a bright display in the overlap region 1110. In some embodiments, the angular separation is large and may be commensurate with the field of view of each sub-image.

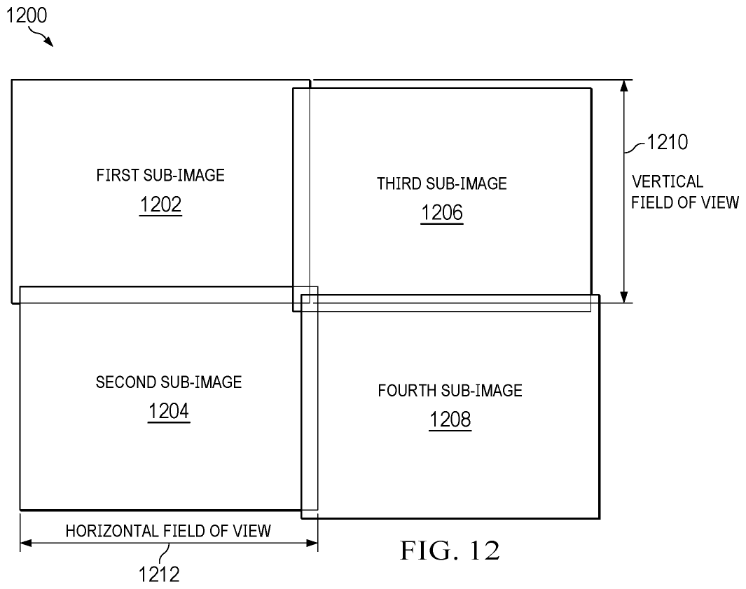

FIG. 12 shows such an example: four sub-images (a first sub-image 1202, a second sub-image 1204, a third sub-image 1206, and a fourth sub-image 1208) are stitched with very little overlap to form a composite total image 1200. Each sub-image has a horizontal field of view 1212 and a vertical field of view 1210. In such examples, each emitter may contribute to forming one region of the total image 1200. The display (including the drive electronics of the lasers) may be calibrated such that only one laser emits in the small regions of overlap, to avoid bright lines in these regions.

In some embodiments, an array of lasers is used and various lasers correspond to different spatial frequencies on the display. For example, a first laser has a high spatial frequency and enables the display of high-resolution elements of an image; a second laser has a lower spatial frequency and enables the display of lower-resolution elements of the image. The high spatial frequency may be at least 2 times (or 3, 5, 10 times) higher than the low spatial frequency. For instance, the high spatial frequency is at least 60 pixels per degree and the low spatial frequency is less than 20 pixels per degree.

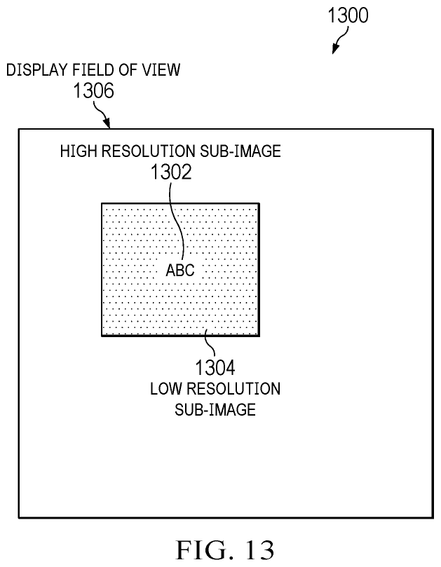

FIG. 13 shows an example of a displayed image 1300 combining two sub-images of varying frequencies. A display system has a field of view 1306. In the illustrated field of view 1306, two sub-images are superimposed: a low-resolution image 1304 is a colored frame and a high-resolution feature 1302 is text information inside the colored frame 1304.

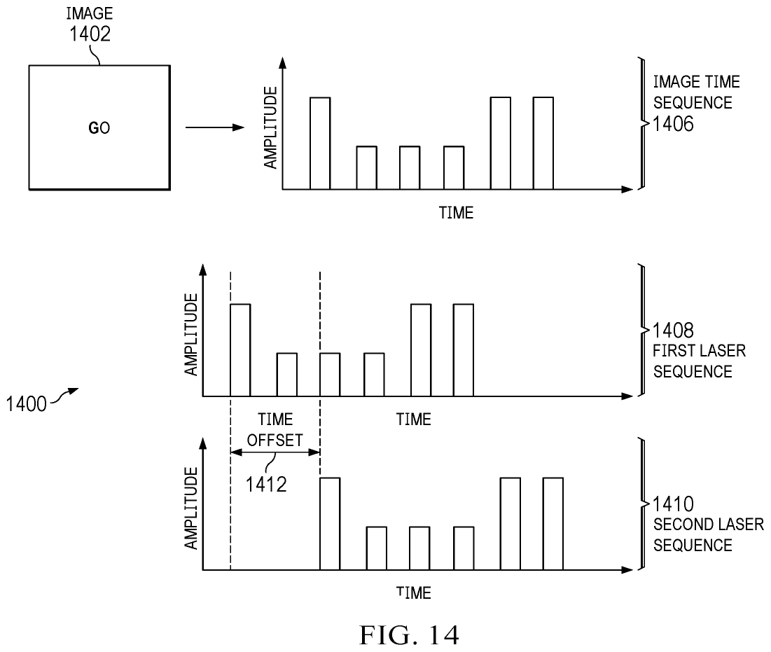

FIG. 14 illustrates an example 1400 of how an image 1402 can be converted in time sequences to drive a multiple-laser display system. For simplicity, only one of the primaries (e.g., the blue primary) is shown. The system has two blue lasers. An image 1402 to be displayed is first converted into an image time sequence 1406, corresponding to the intensity of light to be emitted over time while the display is scanned, so that the image can be rendered. Individual time sequences 1408, 1410 are then derived for each laser. In this example, the second laser sequence 1410 is ‘ahead’ of the first laser sequence 1408 by a time offset 1412. The time offset 1412 may be caused by an angular shift in the laser beam directions, so that the second laser scans a portion of the field of view ahead of the first laser, as shown in FIG. 10. Accordingly, the image time sequence is sent to both lasers, separated by the time offset 1412, so that each laser contributes to forming the image 1402. In regions outside the overlap region of the image, each laser may have an individual time sequence.

In the example of FIG. 14, each pulse in the image time sequence may have a duration of 1 ns (or 2 ns, 5 ns, 10 ns) and be separated by periods of 1 ns (or 2 ns, 5 ns, 10 ns). Each pulse need not correspond to a ‘pixel’ of a displayed image. For instance, each ‘pixel’ may include several pulses. In some examples, the duration of each ‘pixel’ is at least 5 ns (or 10 ns, 20 ns) and some pixels contain several 1 ns-long pulses.

Some embodiments employ methods of calibrating and operating a multiple-laser display, including:
(1) Coupling at least two lasers emitting at a substantially similar wavelength to a laser-scanning system, wherein the lasers illuminate a same point of the display at different times separated by a time offset 1412,
(2) Measuring the time offset 1412 with an accuracy less than the time required to display one pixel,
(3) Using the time offset 1412 to generate time sequences and impart them to the power feeding both lasers, to display images.

The time offset 1412 may be measured directly (i.e., by a time-resolved measurement) or indirectly (i.e., by varying the time offsets between the two lasers and determining a time offset that aligns the images).

By combining several low-power lasers, display systems such as display systems 200, 300, 400, 500, 800, and 900 achieve a high overall display brightness. Rather than using a single ridge laser with a peak power above 50 mW, some embodiments use at least five lasers with a peak power less than 10 mW, resulting in a similar brightness.

In one embodiment, a display system has the following properties: five lasers for each primary, all having a peak power of 5 mW, and an optical assembly including a collimator, a steering element and an optical combiner, having a cumulative power efficiency (watts out of the outcoupler/watts emitted by the lasers) of 1E-4. The combiner has an incoupler pupil with an input area of 1 mm² and an acceptance cone of +/−10 deg, and an outcoupler with an output area of 25 mm² (roughly corresponding to a 5× replication of the incoupler pupil in two directions) and a same emittance cone of +/−10 deg. In this embodiment, the peak irradiance on the outcoupler is about 12.5 W/m²/steradian. If the lasers are balanced to a D65 white emission, the corresponding peak brightness on the outcoupler is about 3700 nits.

More generally, some embodiments facilitate a peak output brightness of at least 1000 nits (or 2000, 3000, 5000, 10000 nits). The brightness may be delivered to the eye of a user.

The table below shows various examples of laser configurations and corresponding brightness levels facilitated by the configurations.

| | # of lasers per | Peak power of | Watts-to-nits | Peak nits |
|---|---|---|---|---|
| Example | primary | each laser (mW) | efficiency | to eye |
| 1 | 2 | 20 | 42,000 | 5,040 |
| 2 | 4 | 10 | 42,000 | 5,040 |
| 3 | 10 | 4 | 42,000 | 5,040 |
| 4 | 2 | 5 | 100,000 | 3,000 |
| 5 | 4 | 2.5 | 100,000 | 3,000 |
| 6 | 10 | 1 | 100,000 | 3,000 |

The watts-to-nits efficiency characterizes the overall efficiency of the system (from the laser emitter to the eye), for substantially white light. A desired efficiency may be obtained by selecting optical components with an appropriate transmission/power efficiency, and by selecting an appropriate source magnification/eyebox replication, as is known in the art. In some embodiments, two or more of the primaries have a different number of lasers. In some examples, the peak power is different for different primaries.

Use of multiple emitters may be beneficial for some display figures of merit. Some figures of merit improve linearly or super linearly with the number of emitters. These include: speckle, peak power density on the retina (for a given total image brightness), and dynamic range.

In some examples, N lasers of a same wavelength are used, each with a dynamic range R, and the system has a dynamic range approximately N*R. The dynamic range is the power range over which an emitter can practically be operated in a system, from a maximum power Pmax to a minimum value Pmin. The dynamic range is defined as Pmax/Pmin. In some embodiments, the dynamic range is higher than 50 (or 100, 200, 1000, 2000, 10000). In some embodiments, a high dynamic range per laser is obtained by driving the laser both in the stimulated emission and the spontaneous emission regimes.

In some examples, an array includes a large number of lasers along one direction, e.g., more than 100 (or 200, 500, 1000); and the beam-steering is only imparted in the orthogonal direction. In such examples, each laser may correspond to a ‘column’ of the final 2D display, and the steering may produce multiple rows for each column.

### Laser Sources

The embodiments discussed herein use laser sources, including laser diodes (LDs). Laser sources may include AlInGaP LDs grown on GaAs substrate emitting red radiation (or infrared, orange, yellow radiation) and AlInGaN LDs grown on GaN substrates emitting violet, blue, cyan, green, yellow, red, infrared radiation.

The LDs may have various geometries, including horizontal lasers such as ridge lasers, or vertical lasers such as vertical-cavity surface-emitting lasers (VCSELs).

In some examples, one or several arrays of lasers are used. An array may be one-dimensional or two-dimensional. In some embodiments, an array comprises, for instance, the following number of elements: 1*2, 1*3, 1*4, 1*5, 1*10, 1*N (with N>2); 2*2, 2*3, 2*4, 2*5, 2*10, 2*N (with N>2); 3*3; 4*4; N*N (with N>2); N*M (with N and M>2). Arrays may also be disposed in a non-regular grid (such as a ring layout).

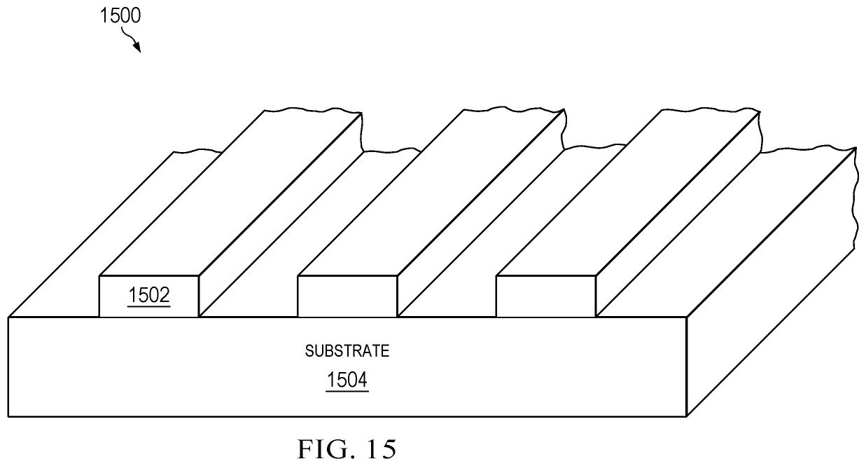

FIG. 15 shows an example of a one-dimensional array 1500 of ridge lasers 1502. For compactness, the ridge lasers 1502 may be formed on a same substrate 1504. This may enable ridge lasers 1502 with a pitch less than 50 um (or 20 um, 10 u, 5 um, 3 um). In some examples, each ridge laser 1502 is monomode and has a width less than 1 um (or 0.5 um, 1.5 um 2 um) and the spacing between ridge lasers 1502 is less than 1 time (or 2, 3, 5, 10 times) the ridge width.

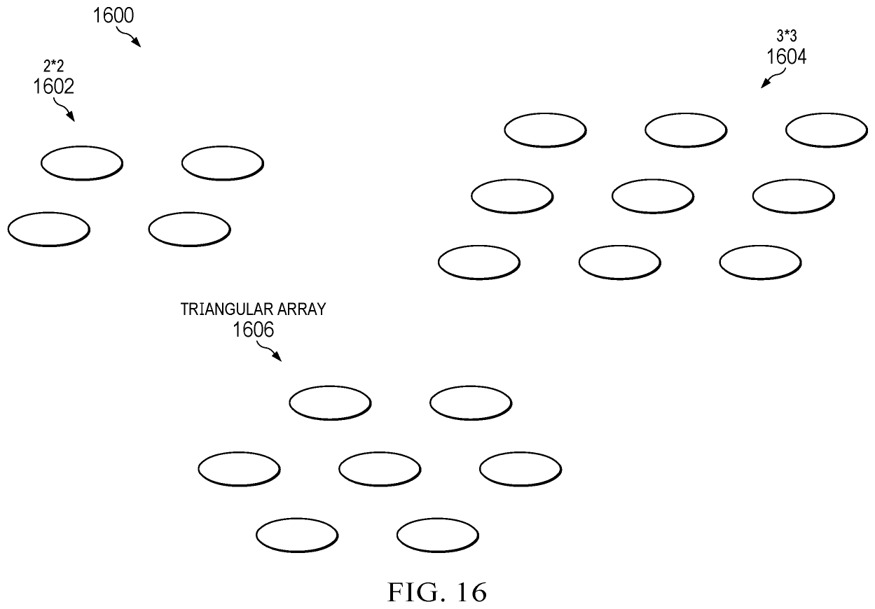

FIG. 16 shows several examples 1600 of two-dimensional arrays of VCSELS: a 2*2 square array 1602, a 3*3 square array 1604, and a 7-laser array 1606 laid on a triangular lattice. Some embodiments include one-dimensional arrays.

Some examples use several arrays of lasers, for instance one for each primary of the display (e.g., blue, green, red, though more than 3 primaries are possible). The multiple arrays may be located in a same emission plane, as shown in FIG. 1. In some embodiments the arrays are separated in space, as shown in FIG. 9.

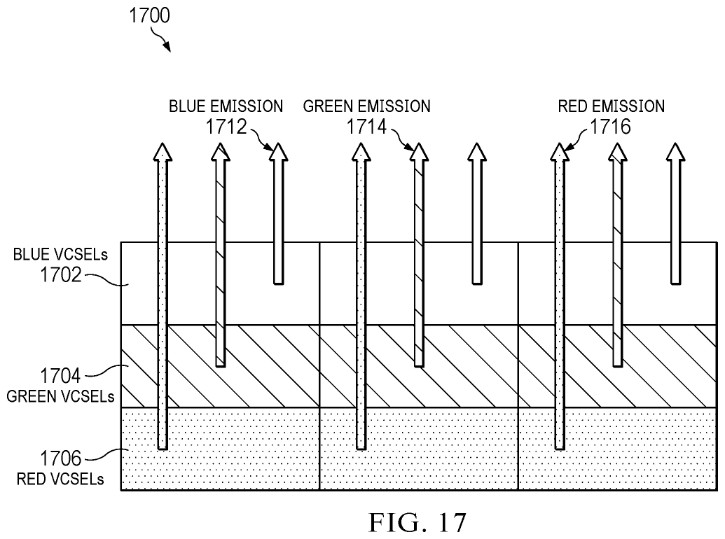

FIG. 17 shows a cross-section of an example 1700 having three arrays that are stacked together vertically (i.e., along the light emission direction). In this example, a red array of VCSELs 1706 is at the bottom, followed by a green array of VCSELS 1704, and a blue array of VCSELS 1702. Clear apertures are formed in the blue and green arrays to allow transmission. The arrays may further be mechanically coupled to a member with high thermal conductance (such as a diamond member or a metal member) to provide high thermal dissipation. High thermal dissipation facilitates operation at peak output power with a junction temperature less than 100 C (or 150 C, 200 C) in each laser.

A VCSEL array may have a pitch of less than 100 um (or 50 um, 40 um, 30 um, 20 u, 10 u, 5 um, 3 um, 2 um). For a two-dimensional array, the layout may be on a square grid, a rectangular grid, a triangular grid. The emitting aperture of each VCSEL may be less than 20% (or 10%, 5%, 2%) of the array pitch.

In some embodiments, an array of lasers is bonded to an array of drivers. Bonding technologies include metal bump interconnects (such as gold-to-gold) and hybrid bonding (e.g., between surfaces having a dielectric and copper contact pads). Metal bumps may be suited for pitches of at least 10 um. Hybrid bonding may be suited for small pitches, e.g., less than 10 um (or 5 um, 3 um, 2 um, 1 um). Hybrid bonding may by wafer-to-wafer, die-to-wafer, or die-to-die. The drivers may be fabricated at a wafer level, for instance using a complementary metal-oxide semiconductor (CMOS) architecture.

The amount of power required to drive the lasers may place a limit on how small the driver pitch can be. Accordingly, the pitch may be smaller in one direction (where the lasers are closely packed) and larger in another direction. In some embodiments, such a pitch is formed at the wafer level, and linear arrays of closely-packed lasers are then formed by singulation.

Each laser in an array may have a maximum output power of less than 20 mW (or 10 mW, 5 mW, 2 mW, 1 mW, 0.5 mW, 0.2 mW, 0.1 mW).

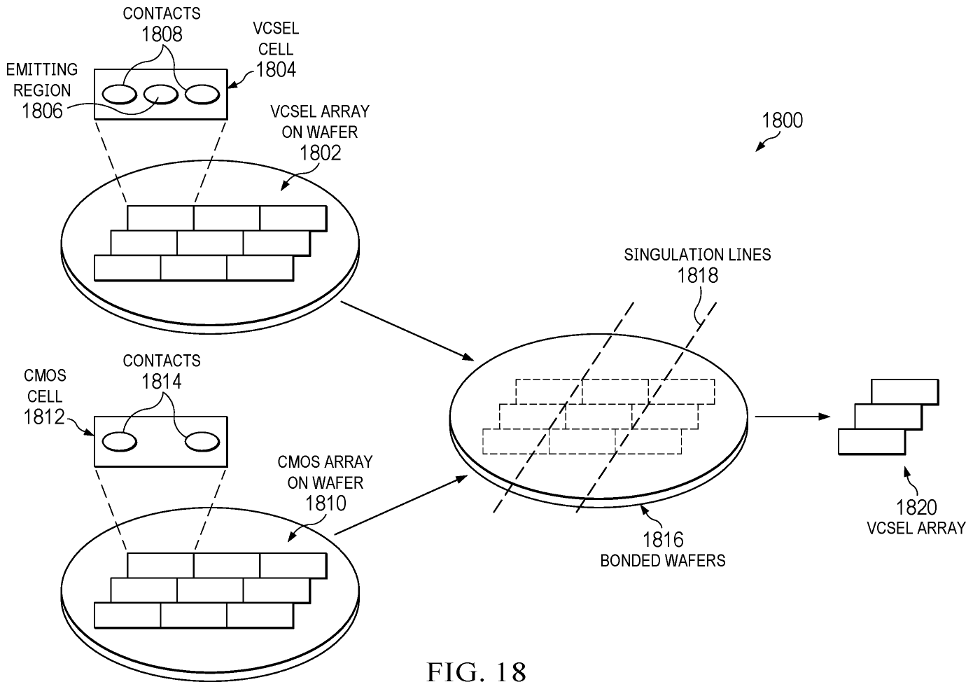

FIG. 18 shows a fabrication flow 1800 for an array of lasers attached to drivers. A first wafer 1802 has a VCSEL array. A cell 1804 of the array has an emitting region 1806 and two contacts 1808 (p and n). Although the contacts 1808 and the emitting region 1806 are shown on the same face, the emission may take place in one direction (e.g., through the substrate of the wafer) whereas the surface of the contacts may be on the opposite face of the wafer (e.g., on the top side). A second wafer 1810 has an array of CMOS cells 1812 (also commonly called pixels). Each cell 1812 has two contacts 1814 configured to mate to the contacts 1808 of the VCSEL cell. In this example, the cells are elongated in one direction, to make room for contacts large enough to drive the required current and to provide good thermal dissipation, and narrow in the other direction, to provide close packing of the VCSELs. For instance, one dimension of the cell is 10 um (or less than 20 um, 40 um) and the other is 50 um (or more than 20 um, 40 um, 60 um, 100 um). The two wafers are bonded to form bonded wafers 1816, for instance using hybrid bonding (in this case, the mating surfaces include dielectric portions and copper via contacts, as is known in the art). Singulation is performed along singulation lines 1818, to yield a one-dimensional VCSEL array 1820 with close packing along the array direction.

In some embodiments where a CMOS is used, each pixel of the CMOS may act as an independent driver for the corresponding laser. In other embodiments, the pixel may only provide part of the driver circuitry (with another part of the driver circuitry being physically separate, and electrically coupled to the pixel) or the pixel may provide electrical connectivity/redirection and be electrically connected to an external driver. In some examples, each pixel of the CMOS is driven independently (i.e., non-sequentially). Independently driving each pixel facilitates modulating the laser at a fast rate, such as using pulses faster than 100 ns (or 50 ns, 10 ns, 5 ns, 2 ns, 1 ns). This contrasts with some conventional active matrix displays where rows of the CMOS are addressed sequentially.

Some embodiments include arrays of VCSEL cells with a first and a second length (e.g., the pitches in both directions, in the case of a 2D array), where the first length is at least 2× (or 3×, 5×, 10×) the second length.

In some embodiments, a similar process flow is used to obtain 2D VCSEL arrays. Even for 2D arrays, close packing may be obtained. For instance, in the case of a 2*N array (2 columns, N lines), the emitting regions of the two columns may be placed next to each other in adjacent cells, with the (+) and (−) contacts formed on either side.

In other cases, the wafer-to-wafer bonding step is replaced with a die-to-wafer or die-to-die step, as is known in the art. For example, if an array of N*M VCSELs on drivers is desired, the process flow includes singulating N*M arrays in the VCSEL wafer and the CMOS wafer to form two chips, and then attaching the two chips.

In some embodiments, the aperture of a VCSEL is selected to obtain a desired beam divergence. The beam divergence may be 5 deg (or 7.5 deg, 10 deg, 12.5 deg, 15 deg, 17.5 deg, 20 deg, 25 deg, 30 deg). The divergence may be defined within a tolerance of +/−0.5 deg (or 1 deg, 2 deg, 5 deg, 10 deg).

In some examples, multiple emitters in an array have distinct lasing wavelengths. The lasing wavelength can be shifted across an array by inserting thin layers that slightly affect the optical path. For example, if a VCSEL has a dielectric mirror, adding a slight thickness of a dielectric layer can shift the optical path and offset the lasing wavelength. The wavelength may be shifted by a predetermined amount, for instance at least 0.1 nm (or 0.5 nm, 1 nm, 1.5 nm 2 nm, 5 nm) between lasers in an array.

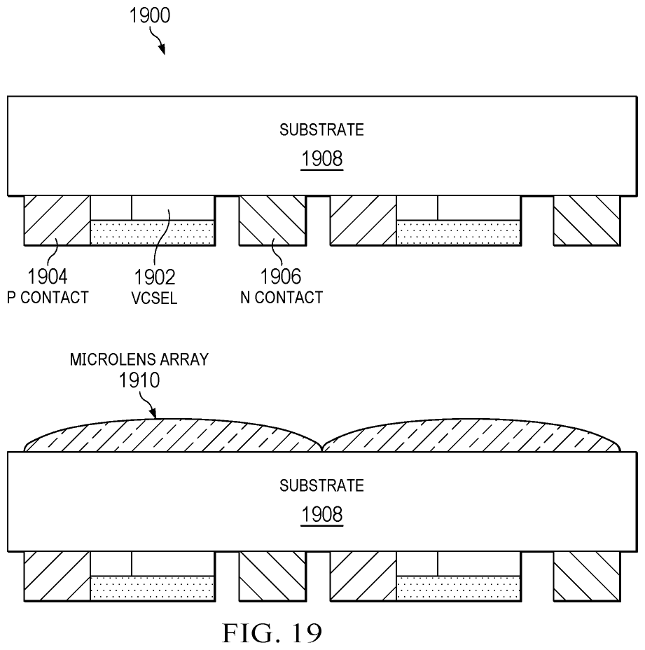

FIG. 19 shows a process 1900 of forming a microlens array 1910. In a first step (top), an on-wafer array of VCSELs 1902 is provided. The VCSELs 1902 are formed on a same substrate 1908. Each VCSEL 1902 has a p-contact 1904 and an n-contact 1906. In this embodiment, the substrate 1908 is transparent and light is emitted through the substrate. Mirrors (not shown) forming the cavity may be placed at various locations in the structure. In a second step (bottom), a microlens array 1910 is formed on the substrate side. In this embodiment, the pitch of the microlens array 1910 is substantially similar to the VCSEL pitch. A slight offset in pitches may be used, as disclosed herein, to obtain different angles for different VCSELs. The array may be formed using standard wafer fabrication techniques (such as photolithography, deposition of materials, etching/liftoff and reflow to obtain a curved lens shape) or by nanoimprint lithography. Such techniques, combined with registration marks in the wafer, may provide alignment accuracy better than 500 nm (or 100 nm, 50 nm, 20 nm, 10 nm, 5 nm).

In some embodiments, the laser emitters have a stable polarization (for instance, linear or circular). This may be advantageous for optical coupling to polarization-sensitive optical elements, such as diffractive elements. In some embodiments, the lasers are ridge lasers with a natural polarization (either transverse electric (TE) or transverse magnetic (TM)). In some examples, the laser emitters are VCSELs, and are configured to have a stable linear polarization in an operation range. In some embodiments, stable linear polarization in an operation range is achieved by forming a gain medium with a preferential/non-isotropic gain direction, e.g., by imparting a strain, including a uniaxial or a biaxial strain to some epitaxial layers, including the light-emitting region of the laser; by forming a cavity with a non-circular shape (such as an oval or elliptical shape); and by inserting a polarization-dependent optical element in the VCSEL (such as a grating, which may be a linear grating along one direction, and may also act as a mirror). In some embodiments, the polarization is stable over a dynamic range of at least 10× (or 100×), such that the laser can be operated from a peak output power P0 to an attenuated value P0/10 (respectively P0/100) with the same polarization.

### Single-Laser Systems

Some embodiments make use of a single low-power emitter per primary, while incorporating features of the previously described embodiments. Some embodiments use optical systems with high optical efficiency to maintain a high brightness.

In one embodiment, a display system includes one laser for each primary, each laser having a peak power of 2 mW. The display system further includes an optical assembly including a collimator, a steering element and an optical combiner, having a cumulative power efficiency (watts out of the outcoupler/watts emitted by the lasers) of 1E-3 (i.e. 0.1%). The optical combiner has an incoupler pupil with an input area of 1 mm² and an acceptance cone of +/−10 deg, and an outcoupler with an output area of 25 mm² (corresponding to a 5× replication of the incoupler pupil in two directions) and a same emittance cone of +/−10 deg. In this example, the peak irradiance on the outcoupler is about 10 W/m2/sr. If the lasers are balanced to a D65 white emission, the corresponding peak brightness on the outoupler is about 3000 nits.

Accordingly, some embodiments make use of optical systems whose cumulative power efficiency E is at least 5E-4 (or 1E-3, 5E-3, 1e-2, 5E-2). In some embodiments, the cumulative power efficiency is the product of three efficiencies E1, E2, E3, corresponding to a first optical element (e.g. a collimator), a steering element, and a combiner. In one example E1=50%, E2=80% and E3=0.25%, leading to E=0.1%.

Some embodiments use combiners with an optical efficiency of at least 0.1% (and as high as 1% or several %). For example, the combiner may be a geometric guide, where light is guided by total internal reflection (TIR), or a holographic waveguide, using a holographic diffractive element with high efficiency. The combiner may also be characterized by a high see-through transmission (i.e. transmission of light from the outside world to the user), such as at least 50% (or 70%, 80%, 90%).

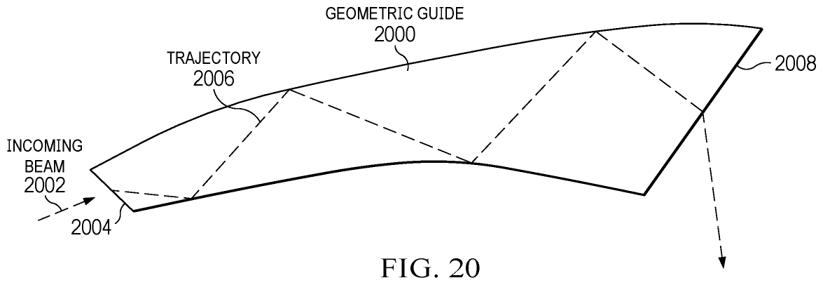

FIG. 20 shows an example of a geometric guide combiner 2000. An incoming laser beam 2002 (steered and shaped appropriately as disclosed herein) is directed to an input facet 2004 of the guide. The beam 2002 follows a trajectory 2006 characterized by a plurality of total internal reflections (TIRs) (e.g., at least 2 or 3 or 4 or 5). The beam 2002 impinges on an output facet 2008 of the guide and is extracted towards the viewer. Due to the TIRs, the optical efficiency of the guide can be high.

Some examples use free-space steering. Instead of being optically coupled to a combiner, light is steered directly in the pupil of the user (for instance, directly from the steering element, or after a reflection on a reflective or diffractive optic). Such systems may be characterized by a high optical efficiency.

Some embodiments use eye tracking to determine the position of the user's pupil. Light is only displayed in a region determined based on the pupil position—for example, a region slightly larger than the pupil position, referred to as a ‘dynamic eyebox’, because only part of the system's full eyebox receives light at a given time. The eye tracking system is fast enough to track pupil motion in some embodiments. In some examples, a system has a maximum eyebox with an area A, but only displays in an area less than A/2 (or A/5, A/10, A/50, A/100). Displaying in a dynamic eyebox facilitates a higher brightness, even if the optical efficiency of the system is low. Thus, if the displayed area is A/N (with N a number), the brightness may be increased by about N—or in other words, the output power of lasers may be reduced by N for a same brightness.

In some examples, the pupil motion is composed of two movements: an involuntary microsaccade movement around a fixed gaze direction, and movements changing the gaze direction. A system generates a display region which is large enough to include a central region corresponding to at least the nominal pupil position, but also a buffer region corresponding to microsaccade movement around the central region. When the gaze direction is changed, the center of the central region is updated.

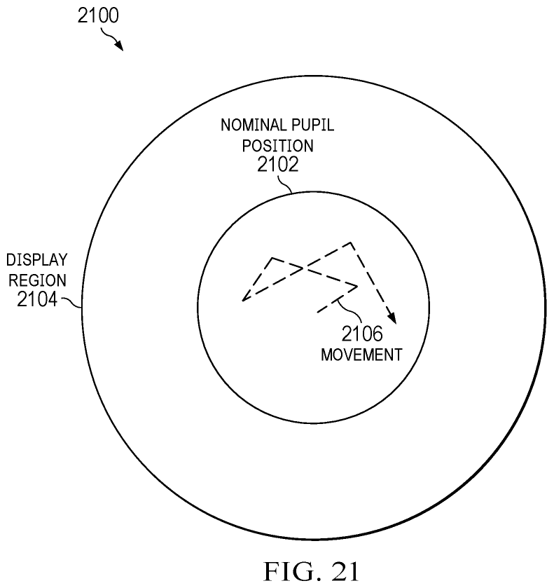

FIG. 21 shows such an example. The nominal pupil position 2102 varies rapidly in time due to the microsaccade movement 2106. The display region 2104 is large enough that the pupil remains in the display region 2104 despite this movement.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A device, comprising:
a first array comprising a plurality of lasers to emit a first color light;
a second array comprising a plurality of lasers to emit a second color light, wherein each laser of the first array and the second array is modulated in time and has a maximum output power less than 10 mW;
an optical element optically coupled to the first array and the second array;
a steering element optically coupled to the optical element; and
an optical combiner optically coupled to the steering element, wherein
the optical element is configured to direct emissions from the first array and the second array to form a light that impinges on the steering element;
the steering element is modulated in time to direct the light in an angular range in which it is optically coupled to the optical combiner; and
the optical combiner is configured to redirect the light to an eyebox, where the light forms a substantially white image having a brightness of at least 1000 nits.

2. The device of claim 1, wherein emissions from any two contiguous lasers in the first array impinge on the steering element with directions separated by an angle less than 5 degrees.

3. The device of claim 1, wherein each laser and the steering element are jointly modulated in time to form the substantially white image.

4. The device of claim 1, wherein the light impinges on the steering element on an area less than 2 mm².

5. The device of claim 1, wherein the substantially white image has a chromaticity which is substantially similar to D65 chromaticity, characterized by a chromatic distance Du‘v’ less than 0.05, and subtends a solid angle of at least 1 deg×1 deg.

6. A method, comprising:
modulating in time and emitting a first color light from a first array comprising a plurality of lasers, each laser having a maximum output power less than 10 mW;
modulating in time and emitting a second color light from a second array comprising a plurality of lasers, each laser having a maximum output power less than 10 mW;
optically coupling an optical element to the first array and the second array to form a light that impinges on a steering element;
modulating the steering element in time to direct the light in an angular range in which the steering element is optically coupled to an optical combiner; and
redirecting the light by the optical combiner to an eyebox to form a substantially white image having a brightness of at least 1000 nits.

7. The method of claim 6, further comprising:
emitting light from any two contiguous lasers in the first array to impinge on the steering element with directions separated by an angle less than 5 degrees.

8. The method of claim 6, further comprising modulating each laser and the steering element in time to form the substantially white image.

9. The method of claim 6, wherein the light impinges on the steering element on an area less than 2 mm².

10. The method of claim 6, wherein the substantially white image has a chromaticity which is substantially similar to D65 chromaticity, characterized by a chromatic distance Du‘v’ less than 0.05, and subtends a solid angle of at least 1 deg×1 deg.

11. A laser-scanning display system comprising:
a blue array comprising a plurality of blue vertical-cavity surface-emitting lasers (VCSELs) optically coupled to a first micro-lens array comprising a plurality of lenses, each lens optically coupled to a laser in the blue array;
a green array comprising a plurality of green VCSELs optically coupled to a second micro-lens array comprising a plurality of lenses, each lens optically coupled to a laser in the green array;
a red array comprising a plurality of red VCSELs optically coupled to a third micro-lens array comprising a plurality of lenses, each lens optically coupled to a laser in the red array;
a steering element optically coupled to the first, second, and third micro-lens arrays; and
an optical combiner optically coupled to the steering element, wherein
the lenses of the micro-lens arrays are configured such that at least 20% of an optical power characterizing emission of light emitted from each VCSEL reaches the steering element.

12. The laser-scanning display system of claim 11, wherein at least 30% of the optical power characterizing emission of light emitted from each VCSEL reaches the steering element.

13. The laser-scanning display system of claim 11, wherein the first micro-lens array is configured such that emissions from all the blue VCSELs are combined into a beam.

14. The laser-scanning display system of claim 11, wherein each VCSEL of the blue array is characterized by a beam angle, and an optical interaction with lens modifies the beam angle.

15. The laser-scanning display system of claim 11, wherein the first micro-lens array is configured such that emissions from the plurality of blue VCSELs substantially overlap at the steering element.

16. The laser-scanning display system of claim 11, wherein each VCSEL in the blue array has an output power less than 10 mW.

17. The laser-scanning display system of claim 11, wherein the system can be operated to form a substantially white image having a brightness of at least 1000 nits.

18. An augmented reality display system comprising:
a first plurality of blue vertical-cavity surface-emitting lasers (VCSELs), wherein each VCSEL has an output power less than 10 mW;
a second plurality of green VCSELs;
a third plurality of red VCSELs;
an optical system optically coupled to the third, second and third pluralities of VCSELs and configured to form an image from light emitted from the third, second and third pluralities of VCSELs; and
an eye-tracking element, wherein electrical powers controlling each VCSEL in the first, second and third pluralities are modulated based on data from the eye-tracking element to facilitate formation of the image.

19. The augmented reality display system of claim 18, wherein one or more VCSELs are turned on or off based on data from the eye-tracking element.

20. The augmented reality display system of claim 18, wherein the augmented reality display system has an eyebox and modulation of the electrical powers controlling each VCSEL causes the eyebox to vary.
